(19) United States
(12) Patent Application Publication
(10) Pub. No.: US 2024/0184026 A1
(43) Pub. Date: Jun. 6, 2024

(54) INFRARED IMAGING SENSOR WITH ANTIREFLECTIVE COATED OPTICS FOR FIRE DETECTION AND FIRE DETECTION DEVICE INCLUDING SAME

(71) Applicant: LINDSEY FIRESENSE, LLC, Azusa, CA (US)

(72) Inventor: Jagdishbhai U. Patel, Granada Hills, CA (US)

(21) Appl. No.: 18/527,010

(22) Filed: Dec. 1, 2023

Related U.S. Application Data
(60) Provisional application No. 63/429,518, filed on Dec. 1, 2022.

(51) Int. Cl. G02B 5/20; G08B 17/12

(52) U.S. Cl. CPC G02B 5/208; G08B 17/125

(57) ABSTRACT

An infrared imaging sensor having antireflective film coated optics for fire detection, and a fire detection device including the same are provided. An infrared imaging sensor for fire detection includes a thermopile array and an antireflective layer on the thermopile lens and configured to pass infrared radiance in a first range corresponding to fire characteristics and block infrared radiance in a second range.

### CROSS-REFERENCE TO RELATED APPLICATION

This application claims the benefit of U.S. Provisional Application No. 63/429,518, filed on Dec. 1, 2022, the entire disclosure of which is incorporated by reference herein.

### BACKGROUND

### 1. Field

Aspects of embodiments of the present invention relate to an infrared imaging sensor having antireflective film coated optics for fire detection, and a fire detection device including the same.

### 2. Description of the Related Art

Prompt detection of fires at the time of ignition, while the fire is still small and manageable, is critical for preventing devastating wildfires. Further, many wildfires are ignited by powerline faults and are often associated with high-wind events in extreme low humidity conditions. Additionally, lack of technology for autonomous night time fire detection has led to several devastating wildfires in recent years.

The above information disclosed in this Background section is for enhancement of understanding of the background of the present disclosure, and therefore, it may contain information that does not constitute prior art.

### SUMMARY

According to an aspect of one or more embodiments of the present disclosure, an infrared (IR) imaging sensor having antireflective film coated optics for fire detection is provided.

According to another aspect of one or more embodiments of the present disclosure, a fire detection device including an infrared imaging sensor having antireflective film coated optics is provided.

According to another aspect of one or more embodiments of the present disclosure, an infrared imaging sensor and a fire detection device including the same are configured to detect small fires from a large distance. According to an aspect, characteristic IR peaks are selected by studying hyperspectral data from numerous fire measurements performed with a variety of vegetation fuels and fuel densities.

According to another aspect of one or more embodiments of the present disclosure, an infrared imaging sensor and a fire detection device including the same are configured to detect a signal from characteristic infrared peaks corresponding to wildfires. Additionally, dependence on space or satellite based fire detection measurements known to have significant atmospheric attenuation and longer time lapses between successive measurements of the same fire may be avoided.

According to another aspect of one or more embodiments of the present disclosure, an infrared imaging sensor and a fire detection device including the same are configured to detect wildfires using infrared radiation with minimal atmospheric attenuation.

According to another aspect of one or more embodiments of the present disclosure, an infrared imaging sensor and a fire detection device including the same are configured to detect wildfires with minimal signal to noise ratio for enhanced sensitivity.

According to one or more embodiments, an infrared imaging sensor for fire detection includes a thermopile, an antireflective layer on the thermopile's plano-convex lens and configured to preferentially pass/allow infrared radiance (in a first range) characteristic of a fire and block infrared radiance (in a second range) from warm surrounding interfering with fire detection.

In one or more embodiments, the infrared imaging sensor for fire detection includes a thermopile focal plane array (FPA) infrared sensor.

In one or more embodiments, the antireflective layer is configured as a coating on a lens arranged on the thermopile focal plane array (FPA).

In one or more embodiments, the infrared radiance in the first range corresponds to a wildfire.

In one or more embodiments, the first range is from 2 μm to 5.5 μm.

In one or more embodiments, the first focused range is from 4.34 μm to 4.7 μm.

In one or more embodiments, the second range is from 6 μm to 15 μm.

According to one or more embodiments, a fire detection device includes a housing, and at least one infrared imaging sensor supported by the housing and comprising a thermopile and an antireflective layer on the thermopile and configured to pass infrared radiance in a first range corresponding to a fire and block infrared radiance in a second range.

In one or more embodiments, at least one infrared imaging sensor forms a focal plane array (FPA) infrared sensor.

In one or more embodiments, the antireflective layer is configured as a coating on a lens arranged on the thermopile imaging array.

In one or more embodiments, the infrared radiance in the first range corresponds to a wildfire.

In one or more embodiments, the first range is from 2 μm to 5.5 μm.

In one or more embodiments, the first range is from 4.2 μm to 4.7 μm.

In one or more embodiments, the second range is from 6 μm to 15 μm.

In one or more embodiments, the at least one infrared imaging sensor includes a plurality of infrared imaging sensors arranged around a periphery of the housing so as to be configured to detect a fire at any of a plurality of sides of the fire detection device.

In one or more embodiments, the fire detection device further includes at least one visible camera configured to obtain an image of an area around the fire detection device in response to an output from the at least one infrared sensor.

In one or more embodiments, the at least one infrared imaging sensor includes a plurality of infrared imaging sensors arranged around a periphery of the housing so as to be configured to detect a fire at any of a plurality of sides of the fire detection device, the at least one visible camera includes a plurality of visible cameras arranged around the periphery of the housing so as to be configured to obtain an image at any of the plurality of sides of the fire detection device, and each of the plurality of infrared sensors and the plurality of cameras is arranged as a fixed array.

In one or more embodiments, the fire detection device further includes an anemometer to determine at least local wind speed and wind direction.

### BRIEF DESCRIPTION OF THE DRAWINGS

The above and other features and aspects will become more apparent to those of ordinary skill in the art by describing in further detail some example embodiments of the present invention with reference to the attached drawings, in which:

FIG. 1 is a graph illustrating IR spectrum transmittance through the atmosphere;

FIG. 2 is a schematic view of an infrared imaging sensor having antireflective film coated optics for fire detection forming a focal plane array infrared camera system, according to an embodiment of the present disclosure;

FIG. 3 is a graph illustrating IR transmission through antireflective film coated optics for fire detection of an infrared sensor, according to an embodiment of the present disclosure;

FIG. 4 is a graph illustrating atmospheric transmission of IR peaks based on differential between the simultaneous space based and ground based spectral measurements done on the same fire, determined as ideally suited for fire detection.

FIG. 5 is a view of a fire detection device according an embodiment of the present disclosure.

### DETAILED DESCRIPTION

Herein, some example embodiments will be described in further detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and, thus, descriptions thereof may not be repeated.

In the drawings, relative sizes of elements, layers, and regions may be exaggerated and/or simplified for clarity.

It is to be understood that, although the terms “first,” “second,” “third,” etc., may be used herein to describe various elements, components, regions, layers and/or sections, these elements, components, regions, layers, and/or sections are not limited by these terms. These terms are used to distinguish one element, component, region, layer or section from another element, component, region, layer, or section. Thus, a first element, component, region, layer, or section described below could be termed a second element, component, region, layer, or section, without departing from the spirit and scope of the present disclosure.

It is to be understood that when an element or layer is referred to as being “on,” “connected to,” or “coupled to” another element or layer, it may be directly on, connected to, or coupled to the other element or layer, or one or more intervening elements or layers may be present.

The terminology used herein is for the purpose of describing particular embodiments and is not intended to be limiting of the present disclosure. As used herein, the singular forms “a” and “an” are intended to include the plural forms as well, unless the context clearly indicates otherwise. It is to be further understood that the terms “comprises,” “comprising,” “includes,” and “including,” “has,” “have,” and “having,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless otherwise defined, all terms (including technical and scientific terms) used herein have the same meaning as commonly understood by one of ordinary skill in the art to which the present disclosure belongs. It is to be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

Embodiments of the present invention provide an imaging sensor and a fire detection device configure to detect a fire (e.g., a wildfire) during both day and night by the characteristic infrared (IR) radiance of the fire. Additionally, embodiments of the present invention are configured to detect such fires with improved sensitivity and accuracy by avoiding or reducing interference from warm or hot surrounding objects, such that small fires (e.g., as small as 10 square feet in size) may be detected at a point of ignition from a large distance away (e.g., from up to 1,000 feet away), thereby allowing quick response time so that the fire can be extinguished while still small.

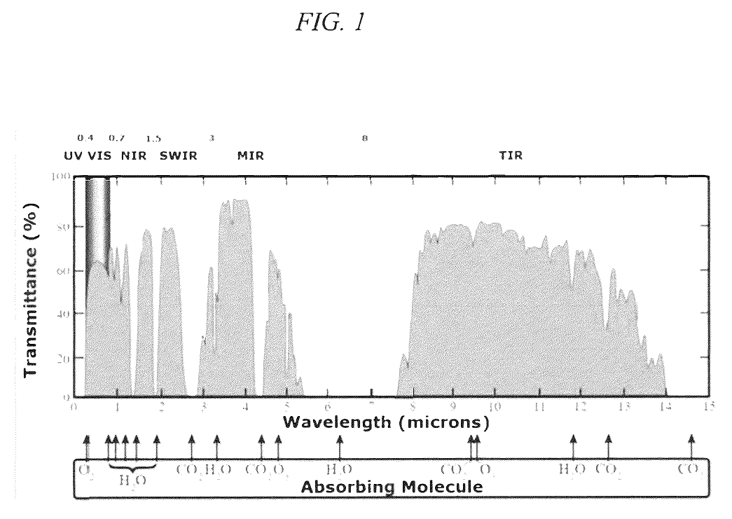

Conventionally, ground based scanning and satellite-based IR cameras have been used in detection and imaging devices. However, such scanning devices require human attendance for data processing and interpretation, and space based cameras and devices are expensive and provide limited coverage with larger thresholds on fires that could be detected. Moreover, it is known that IR radiation is attenuated in the atmosphere by absorption, scattering, and refraction. FIG. 1 is a graph illustrating transmittance through the atmosphere in a range of the IR spectrum. As illustrated in FIG. 1, atmospheric molecules, such as H₂O, O₂ and CO₂, may absorb photons in IR radiation to a greater degree in certain wavelength bands. For example, as shown in the figure, bands with low absorption, or transmission windows, exist at ranges of 3-5 μm and 8-12 μm. Additionally, studies have shown that there is a correlation between IR radiance and types, densities, and volumes of fuels burned, and that wildfires may emit characteristic IR peaks in a mid-IR range substantially corresponding to 3-5 μm and, in particular, at around 4.3 μm, suggesting that detecting fires may be easier in the mid-IR range rather than a thermal IR range in the presence of a hot background.

Therefore, according to embodiments of the present invention, an on-ground IR imaging sensor and device for detecting fires (e.g., wildfires) are provided using a low-cost imaging sensor and having a high signal-to-noise ratio due to reduced atmospheric attenuation of the sensed IR radiation, so as to more efficiently and accurately detect the fires.

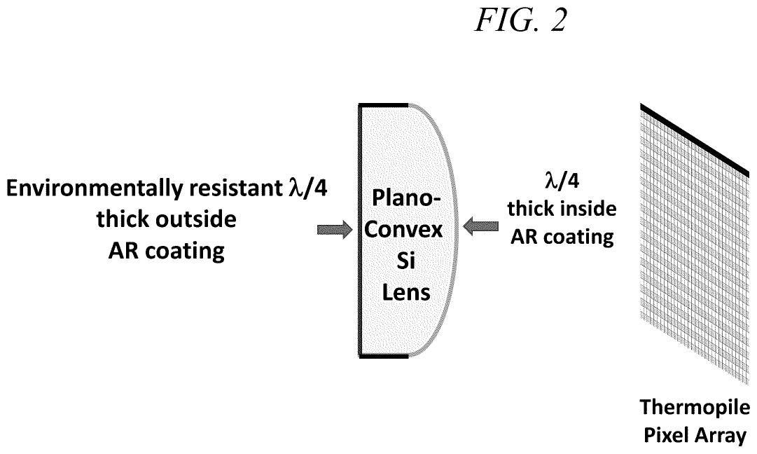

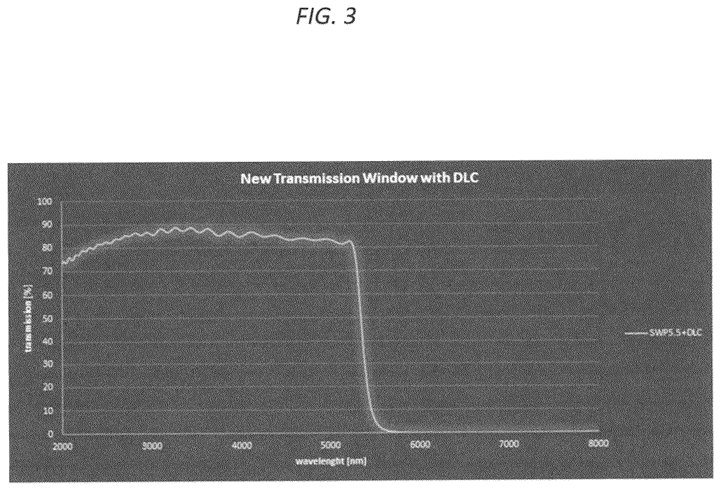

FIG. 2 is a schematic view of an infrared imaging sensor having antireflective film coated optics for fire detection, according to an embodiment of the present disclosure; and FIG. 3 is a graph illustrating transmission through antireflective film coated optics for fire detection of an infrared sensor, according to an embodiment of the present disclosure.

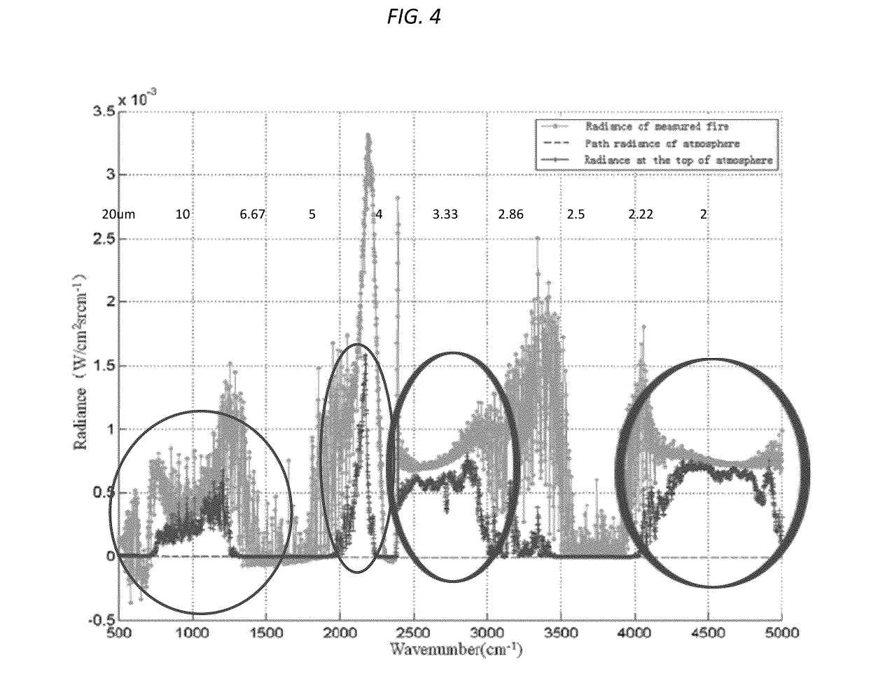

According to embodiments of the present invention, an infrared sensor for fire detection includes an antireflective layer on both sides of a plano-convex lens of a thermopile and configured to pass infrared radiance in a first range corresponding to a fire and block infrared radiance in a second range. That is, by blocking the infrared radiance in the second range, interference or noise from surrounding hot objects (e.g., vehicles, terrain, structures, chimneys), as well as solar interference, may be reduced, such that fires which are smaller in size and/or farther away may be detected. In one or more embodiments, as illustrated in FIG. 3, the infrared radiance in the first range is a range from 2 μm to 5.5 μm (2 μm to 5.5 μm, or about 2 μm to about 5.5 μm) and, in an embodiment, from 4.2 μm to 4.7 μm (4.2 μm to 4.7 μm, or about 4.2 μm to about 4.7 μm), as illustrated in FIG. 4, and corresponds to a range in which wildfires have characteristic emission peaks. Further, in one or more embodiments, the second range may be from 6 μm to 15 μm (6 μm to 15 μm, or about 6 μm to about 15 μm). However, embodiments are not limited to the above-described ranges. For example, the first range may be a range from 2 μm to 6 μm (2 μm to 6 μm, or about 2 μm to about 6 μm) or a range from 3 μm to 6 μm (3 μm to 6 μm, or about 3 μm to about 6 μm). Further, in one or more embodiments, the second range may be from 6 μm to 14 μm (6 μm to 14 μm, or about 6 μm to about 14 μm). In one or more embodiments, the antireflective film coated optics may decrease reflectance in 3-6 μm wavelengths below 5% and increase transmittance to greater than 95%, and may increase reflectance above 6 μm by 35-60% to block IR transmittance at this range of wavelengths.

FIG. 4 is a graph illustrating atmospheric transmission of IR for selection of wavelengths for fire detection with an infrared imaging sensor described here As shown in FIG. 4, a leftmost circled region illustrates a range of wavelengths detected by a conventional thermopile, whereas the three regions circled to the right illustrate ranges of antireflective film coated optics for fire detection of an infrared sensor, according to embodiments of the present disclosure.

In one or more embodiments, the thermopile is a focal plane array (FPA) infrared sensor or a COTS (commercial off the shelf) thermopile array in which pixels on the sensor array absorb incident heat flux from infrared radiation to generate a voltage signal, and may be manufactured by Heimann Sensor GmbH, for example. For example, an existing COTS thermopile manufactured by Heimann Sensor GmbH may have a 5 μm to 15 μm IR window and may be configured for IR imaging at room temperature. As such, the thermopile may be a low-cost sensor which, when configured with the AR coated optics of the present invention, may be employed in the fire detection device of the present invention. In one or more embodiments, the thermopile may include a Si or Ge lens, and the lens may be a plano-convex lens. That is, the lens may have a planar outer surface and a convex inner surface. Additionally, in one or more embodiments, the pixels of the focal plane array (FPA) have an optimized shape to provide improved signal strength and detection efficiency at the characteristic wavelengths emitted by wildfires. In an embodiment, the pixels may be square and may be arranged in a 32×32 matrix, although embodiments of the present invention are not limited thereto.

In one or more embodiments, the antireflective (AR) coating on the lens is an outside diamond like coating (DLC) layer, which provides resistance to degradation due to environmental factors, such as rain, moisture, humidity, dust and wind abrasion, high temperatures, and sun exposure. For example, the DLC layer may be formed from a class of amorphous carbon material that displays some of the typical properties, such as hardness, of diamond. Further, the DLC layer may have a low friction coefficient and high wear resistance, so as to be resistant to abrasion, and may also be resistant to salts, acids, alkalis, and organic solvents. In an embodiment, the lens has a coating thickness of λ/4, which means that the anti-reflective DLC is applied at a thickness equal to ¼ of the median wavelength of the first range described herein. For example, in an embodiment, when the median of the first range is 3.75 μm, the thickness may be about 0.938 μm. In an embodiment, each of the outer surface of the lens and the inner surface of the lens has an antireflective coating thickness of λ/4. Further, in an embodiment, the inner surface may have a coating comprised of multiple layers of Ge and ZnS or similar materials having a total thickness of λ/4.

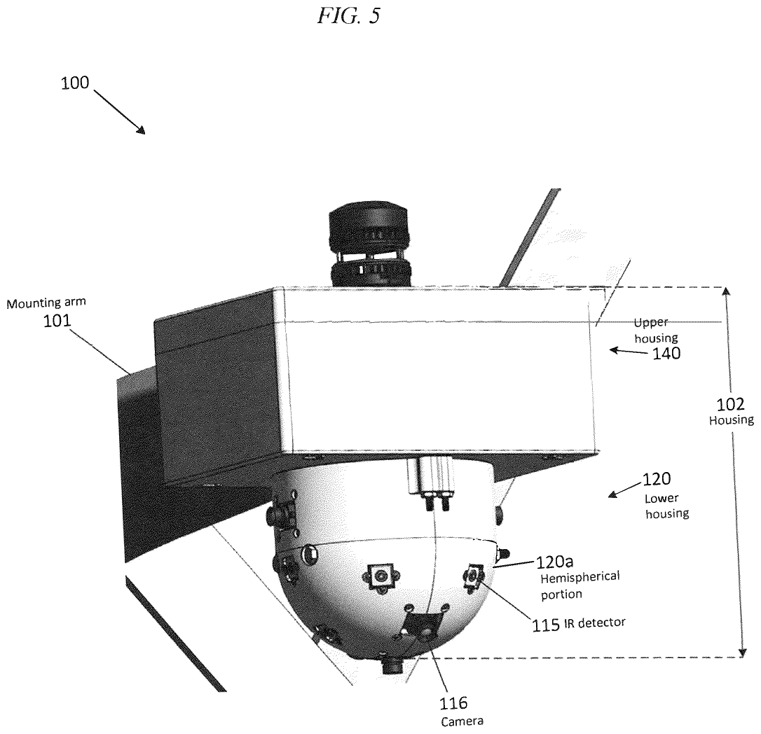

FIG. 5 is a perspective view of a device 100 for fire detection according to one or more embodiments of the present disclosure.

The device 100 for fire detection includes one or more IR detectors 115, which may each be an IR detector according to an embodiment of the present invention as described above. In an embodiment, the device 100 for fire detection includes a plurality of the IR detectors 115. In an embodiment, the device 100 for fire detection may further include one or more cameras 116 and, in an embodiment, a plurality of the cameras 116. In an example embodiment, the device 100 for fire detection may obtain a signal from the IR detectors 115 corresponding to a characteristic peak for a fire (e.g., a wildfire), pass the output of a plurality of the IR detectors 115 through a neural network algorithm within the device 100 for fire detection itself, and, if it is confirmed that a potential fire (e.g., wildfire) condition is present, then may pass an output of the one or more cameras 116 through a separate neural network to confirm the presence of a fire (e.g., wildfire) condition. As such, the device 100 for fire detection may be configured to operate autonomously by processing data therein and thereby minimize or reduce detection time while also minimizing or reducing the occurrence of false alarms. Additionally, as the device 100 includes one or more neural networks, the device 100 may continuously learn from previously collected data to improve efficiency and avoid false alarms.

As shown in FIG. 5, in one or more embodiments, the device 100 for fire detection may include a housing 102 which is mountable on (e.g., directly mountable on) a mounting arm 101, such as on a tower for supporting an electrical power line. In another embodiment, the housing 102 may be mountable on (e.g., directly mountable on) a conductor, or electrical power line, itself, and, in an embodiment, may be powered by the electrical power line. However, embodiments of the present invention are not limited thereto and may be mounted, for example, near roadways, pipelines, railroads, or other critical boundaries for fire detection. In one embodiment, for example, the device 100 may include two cameras 116 directed in opposing directions, such as along an electrical power line, and six of the IR detectors 115 to provide a wide range of coverage. The cameras 116, for example, may be employed to provide confirmation of a fire after a signal from the IR detectors 115 has been received. Further, in one embodiment, for example, the device 100 may scan for heat every thirty seconds, for example, and, if heat is detected, then the device 100 may provide power to the cameras 116. As such, a system of power conservation may be provided. Additionally, a plurality of the devices 100 for fire detection may be placed at an interval (e.g., approximately four devices per mile) to provide continuous wildfire detection. In one or more embodiments, the housing 102 of the device 100 for fire detection may accommodate radio or hardware communication circuitry, an integral or external magnetic field harvesting power supply, a solar panel power supply, and/or a battery, for example.

In one or more embodiments, the device 100 for fire detection may include a processing circuit and may be part of an electronic communication system that is the same or similar to that described in U.S. patent application Ser. No. 17/121,705, the entire disclosure of which is incorporated herein by reference. In one or more embodiments, for example, all computing may be performed by the processing circuit of the device 100, and the device 100 may send out alarms in connection with results of the computing. Therefore, further description of the processing circuit and the electronic communication system associated with the device 100 for fire detection will not be provided.

In one or more embodiments, the housing 102 may include an upper housing 140 and a lower housing 120. In an embodiment, the upper housing 140 may be substantially rectangular, while the lower housing 120 may include a hemispherical portion 120a. However, a configuration of the housing 102 is not limited thereto. The hemispherical portion 120a may provide a mounting surface for sensors (e.g., the IR detectors 115 and the cameras 116) positioned to take measurements at different angles toward a surface of the ground below the monitor 100. In an embodiment, a plurality of the IR detectors 115 is arranged around a perimeter of the hemispherical portion 120a, such that the device 100 for fire detection may detect a fire at all sides. Further, the device 100 for fire detection may be a fixed (“staring”) type, rather than a scanning type, thereby providing improved absorption of heat flux and also reducing response time. The housing 102 may be made of a suitable material that can survive harsh wildfire weather conditions (e.g., heat and smoke) and harsh non-wildfire weather conditions (e.g., rain and snow). In one or more embodiments, the sensors may include additional sensors, such as an anemometer to determine at least one of a wind speed and a wind direction. As such, the device 100 may be configured to determine at least one of a speed and a direction in which a fire will travel.

Although some example embodiments have been described herein, those skilled in the art will readily appreciate that various modifications are possible in the example embodiments without departing from the spirit and scope of the present disclosure. It is to be understood that descriptions of features or aspects within each embodiment should typically be considered as available for other similar features or aspects in other embodiments, unless otherwise described. Therefore, it is to be understood that the foregoing is illustrative of various example embodiments and is not to be construed as limited to the specific example embodiments disclosed herein, and that various modifications to the disclosed example embodiments, as well as other example embodiments, are intended to be included within the spirit and scope of the present disclosure as set forth in the appended claims, and their equivalents.

What is claimed is:

1. An infrared imaging sensor for fire detection comprising:
a thermopile; and
an antireflective layer on a lens of the thermopile and configured to pass infrared radiance in a first range corresponding to a fire and block infrared radiance in a second range.

2. The infrared imaging sensor for fire detection of claim 1, comprising a focal plane array (FPA) infrared sensor.

3. The infrared imaging sensor for fire detection of claim 1, wherein the antireflective layer is configured as a coating on the lens of the thermopile for achieving selective transmission of IR suited for small fires detection at far distances.

4. The infrared imaging sensor for fire detection of claim 1, wherein the infrared radiance in the first range corresponds to a wildfire.

5. The infrared imaging sensor for fire detection of claim 1, wherein the first range is from 2 μm to 5.5 μm.

6. The infrared imaging sensor for fire detection of claim 5, wherein the first range is from 4.2 μm to 4.7 μm.

7. The infrared sensor for fire detection of claim 1, wherein the second range is from 6 μm to 15 μm.

8. A fire detection device comprising:
a housing; and
at least one infrared imaging sensor supported by the housing and comprising a thermopile focal plane array (FPA) with antireflective layers on the thermopile lens configured to pass infrared radiance in a first range corresponding to a fire and block infrared radiance in a second range.

9. The fire detection device of claim 8, wherein the at least one infrared imaging sensor comprises a focal plane array (FPA) infrared sensor.

10. The fire detection device of claim 8, wherein the antireflective layer is configured as a coating on a lens arranged on the thermopile.

11. The fire detection device of claim 8, wherein the infrared radiance in the first range corresponds to a wildfire.

12. The fire detection device of claim 8, wherein the first range is from 2 μm to 5.5 μm.

13. The infrared sensor for fire detection of claim 12, wherein the first range is from 4.2 μm to 4.7 μm.

14. The fire detection device of claim 8, wherein the second range is from 6 μm to 15 μm.

15. The fire detection device of claim 8, wherein the at least one infrared sensor comprises a plurality of infrared imaging sensors arranged around a periphery of the housing so as to be configured to detect a fire at any of a plurality of sides of the fire detection device.

16. The fire detection device of claim 8, further comprising at least one visible camera configured to obtain an image of an area around the fire detection device in response to an output from the at least one infrared imaging sensor.

17. The fire detection device of claim 16,
wherein the at least one infrared imaging sensor comprises a plurality of infrared sensors arranged around a periphery of the housing so as to be configured to detect a fire at any of a plurality of sides of the fire detection device,
wherein the at least one visible camera comprises a plurality of cameras arranged around the periphery of the housing so as to be configured to obtain an image at any of the plurality of sides of the fire detection device, and
wherein each of the plurality of infrared imaging sensors and the plurality of cameras is arranged as a fixed array.

18. The fire detection device of claim 8, further comprising an anemometer to determine local wind speed and a wind direction.
